(19) United States
(12) Patent Application Publication
(10) Pub. No.: US 2011/0027641 A1
(43) Pub. Date: Feb. 3, 2011

(54) RECHARGEABLE BATTERY PACK WITH AT LEAST ONE ELECTROCHEMICAL CELL ARRANGED IN A HOUSING STRUCTURE

(76) Inventor: Marcin Rejman, Waiblingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/934,862

(22) PCT Filed: Dec. 18, 2008
(86) PCT No.: PCT/EP08/67872

§ 371 Date: Sep. 27, 2010

(30) Foreign Application Priority Data
Mar. 26, 2008 (DE) 10 2008 000 834.6

(51) Int. Cl. H01M 10/50

(52) U.S. Cl. 429/120

(57) ABSTRACT

The invention is based on a rechargeable battery pack with at least one electrochemical cell arranged in a housing structure. The invention proposes that at least regions of the housing structure have a memory material, which can be plastified under heat absorption.

### PRIOR ART

The invention is based on a rechargeable battery pack with at least one electrochemical cell situated in a housing structure, according to the preambles to the independent claims.

As a rule, rechargeable battery packs are encompassed by a plastic housing that protects the electrochemical cells on the interior from external influences. When in use, modern rechargeable battery packs, in particular lithium ion packs, are frequently operated at their thermal limit. By means of a thermal cutoff limit that exists anyway, when an overheating is imminent, a set of protective electronics interrupts the flow of current.

In extreme cases, the rechargeable battery pack can be situated in an environment that cannot be controlled electronically, e.g. on a hot plate, in the vicinity of a furnace, and the like. In these cases, the temperature inside the rechargeable battery pack can exceed a critical threshold which results in the destruction of the rechargeable battery pack.

### DISCLOSURE OF THE INVENTION

The invention is based on a rechargeable battery pack with at least one electrochemical cell situated in a housing structure.

In at least some regions, the proposed housing structure has a storage material that has the capacity to plastify when it absorbs heat.

The storage material is advantageously composed of a semicrystalline material, preferably a semicrystalline plastic. A solid that has both amorphous and crystalline regions (domains) is referred to as semicrystalline. For example, if the melt of a polymer is cooled, the polymer chains begin to crystallize in a regular configuration. But since the polymer chains are entangled with one another, this process cannot take place in the entire volume, but only in certain domains. In the rest of the sample, the chains solidify randomly, i.e. amorphously.

The slower the melt is cooled, the better polymers crystallize. Isotactic and syndiotactic polymers crystallize. Atactic polymers only crystallize if the substituents are very small, as is the case with polyvinyl chloride, for example. Polymers with small side chains crystallize better than those with large side chains. As a rule, cross-linked or branched polymers do not crystallize.

If the storage material begins to plastify due to heating, the crystallized regions melt as they absorb heat and therefore absorb a relatively large quantity of heat over a certain time span. During this time span, the heated rechargeable battery pack would in any case be deformed by the softening of the storage material. The heat absorbed by the housing structure, however, can penetrate to the electrochemical cells only after all of the semicrystalline regions have melted. This time lag provides a safety reserve for the rechargeable battery pack.

The properties of the housing structure can advantageously be adapted to the electrochemical cells and/or the intended use of the rechargeable battery pack. This can be achieved by means of the material selection and/or by means of the interior design of the housing structure. The at least one electrochemical cell on the interior of the housing structure advantageously enjoys an increased protection from thermal overload and it is possible to avoid destruction of the rechargeable battery pack at least for the span of time it takes until all of the semicrystalline regions have melted.

The housing structure can be composed of the thermal storage material. This enables a simple manufacture and design of the housing structure. Preferably, the storage material is composed of a semicrystalline material.

The housing structure can have a first component that provides a predominantly mechanical protection and as the second component, can have the thermal storage material. Preferably, the first component can be situated on a housing exterior and the second component can be situated on a housing interior.

According to an advantageous embodiment, the first component can constitute a housing exterior. An advantageous modification, the second component can constitute a housing interior. In this case, the housing structure can be composed of a layered composite. Advantageously, the outer layer essentially determines the mechanical properties of the housing structure while the inner layer essentially determines the thermal properties of the housing structure.

Alternatively or in addition, at least some regions of the housing structure can be composed of a mixture of the first and second components in accordance with a matrix composite or blend in which the second component in the form of a dispersed phase is mixed into a coherent matrix, which preferably determines the mechanical properties of the housing structure and corresponds to those of the first component.

Preferably, at least some regions of the housing structure can be composed of plastic.

Particularly preferably, the second component can be a semicrystalline plastic.

According to an advantageous modification of the invention, a plurality of electrochemical cells can be situated inside the housing structure and one or more inner cores can be situated between the electrochemical cells.

### BRIEF DESCRIPTION OF THE DRAWINGS

### Drawings

Other advantages ensue from the following description of the drawings. The drawings show exemplary embodiments of the invention. The person skilled in the art will also suitably consider the features disclosed in the drawings, the description, and the claims individually and unite them in other meaningful combinations.

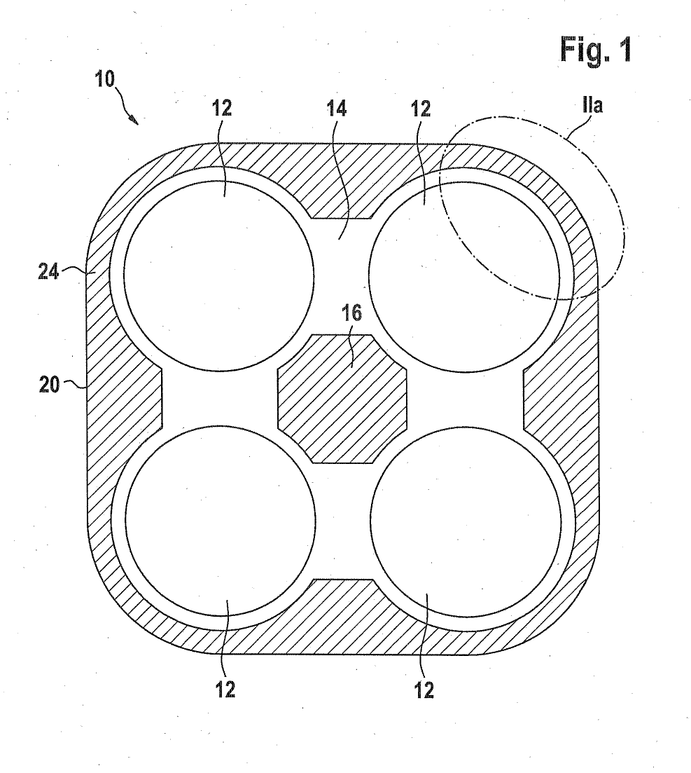

FIGS. 1a, b show a cross-section through a rechargeable battery pack with four electrochemical cells on the interior of the housing structure; and

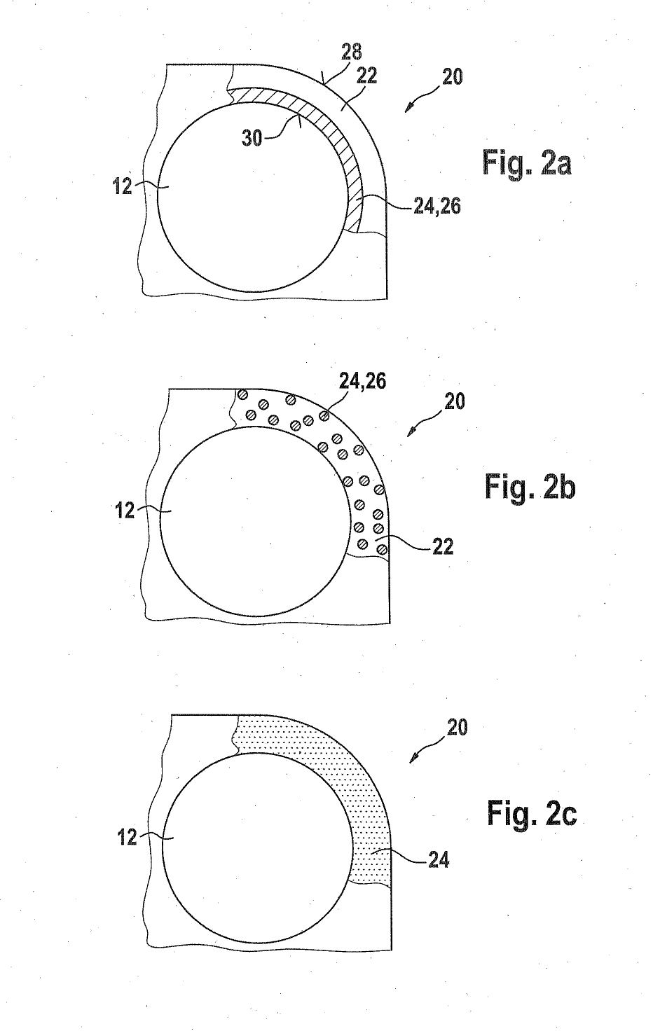

FIGS. 2a-2c are detail views of parts of rechargeable battery packs according to FIG. 1, in an embodiment in the form of a layered composite (FIG. 2a), a blend (FIG. 2b), and a monolithic material (FIG. 2c).

### EMBODIMENTS OF THE INVENTION

In the drawings, components that are the same or similar have been labeled with the same reference numerals.

To permit explanation of the invention, FIG. 1 shows a rechargeable battery pack 10 with four electrochemical cells 12 situated in a housing structure 20. An inner core 16 is situated on the interior 14 of the housing structure 20 and is surrounded by the four electrochemical cells 12. In at least some regions, the housing structure has a storage material 24 that has the capacity to plastify when it absorbs heat. In the plastified state, the storage material 24 is soft, but not yet fluid.

Preferably, the storage material 24 is composed of a semicrystalline plastic material. A midsized housing structure 20 according to the invention that contains, for example, four electrochemical cells 12 can provide the electrochemical cells 12 with thermal protection for approximately 90 minutes at a surrounding temperature of 150° C.

FIGS. 2a-2c show some possible preferred embodiments of the housing structure 20 from FIG. 1.

According to FIG. 2a, the housing structure 20 can be composed of a first component 22 and a second component 26; the first component 22 constitutes a housing exterior 28 of the housing structure 20 and the second component 24 constitutes a housing interior 30. The electrochemical cells 12 in this case can be spaced apart from or in contact with the housing interior 30. If the housing interior 30 is spaced apart from the electrochemical cells 12, the gap between the electrochemical cells 12 and the housing interior 30 can optionally be filled with a thermally insulating material.

In particular, the housing interior 30 in the contacting region can be formed to duplicate the outer contour of the electrochemical cells 12. The housing exterior 28 provides the mechanical protection for the electrochemical cells 12 and the housing interior 30 provides the thermal protection from overheating, preferably from the outside.

FIG. 2b shows an embodiment in which the housing structure 20 is composed of a matrix composite (blend). The first component 22 constitutes a matrix that provides a predominantly mechanical protection. The second component 26, which is constituted by the storage material 24, is embedded as a dispersed phase into the coherent phase of the matrix and provides the thermal protection for the electrochemical cells 12.

FIG. 2c shows an embodiment in which the housing structure 20 is composed of a monolithic body made of the thermal storage material 24 that is preferably composed of a semicrystalline thermoplastic. In this exemplary embodiment, the thermal storage material 24 inherently combines the protective mechanical and thermal properties.

Naturally, combinations of the various embodiments in a combined housing 20 are also conceivable.

1-10. (canceled)

11. A rechargeable battery pack with at least one electrochemical cell situated in a housing structure which has in at least some regions, a thermal storage material that has the capacity to plastify when it absorbs heat.

12. The rechargeable battery pack as recited in claim 11, wherein the housing structure is composed of the thermal storage material.

13. The rechargeable battery pack as recited in claim 11, wherein the housing structure has a first component, which provides a predominantly mechanical protection, and, has a second component made of the thermal storage material.

14. The rechargeable battery pack as recited in claim 13, wherein the first component is situated on a housing exterior and the second component is situated on a housing interior.

15. The rechargeable battery pack as recited in claim 13, wherein the first component constitutes a housing exterior.

16. The rechargeable battery pack as recited in claim 14, wherein the first component constitutes a housing exterior.

17. The rechargeable battery pack as recited in claim 13, wherein the second component constitutes a housing interior.

18. The rechargeable battery pack as recited in claim 14, wherein the second component constitutes a housing interior.

19. The rechargeable battery pack as recited in claim 15, wherein the second component constitutes a housing interior.

20. The rechargeable battery pack as recited in claim 16, wherein the second component constitutes a housing interior.

21. The rechargeable battery pack as recited in claim 13, wherein in at least some regions, the housing structure is composed of a mixture of the first and second components.

22. The rechargeable battery pack as recited in claim 14, wherein in at least some regions, the housing structure is composed of a mixture of the first and second components.

23. The rechargeable battery pack as recited in claim 15, wherein in at least some regions, the housing structure is composed of a mixture of the first and second components.

24. The rechargeable battery pack as recited in claim 17, wherein in at least some regions, the housing structure is composed of a mixture of the first and second components.

25. The rechargeable battery pack as recited in claim 12, wherein in at least some regions, the housing structure is composed of plastic.

26. The rechargeable battery pack as recited in claim 13, wherein in at least some regions, the housing structure is composed of plastic.

27. The rechargeable battery pack as recited in claim 24, wherein in at least some regions, the housing structure is composed of plastic.

28. The rechargeable battery pack as recited in claim 12, wherein the second component is a semicrystalline plastic.

29. The rechargeable battery pack as recited in claim 13, wherein the second component is a semicrystalline plastic.

30. The rechargeable battery pack as recited in claim 11, wherein a plurality of electrochemical cells is situated inside the housing structure and one or more inner cores is/are situated between the electrochemical cells.
